(19) United States
(12) Patent Application Publication
(10) Pub. No.: US 2013/0208809 A1
(43) Pub. Date: Aug. 15, 2013

(54) MULTI-LAYER RATE CONTROL

(71) Applicants: Mei-Hsuan Lu, Bellevue, WA (US); Ming-Chieh Lee, Bellevue, WA (US)

(72) Inventors: Mei-Hsuan Lu, Bellevue, WA (US); Ming-Chieh Lee, Bellevue, WA (US)

(73) Assignee: MICROSOFT CORPORATION, Redmond, WA (US)

(21) Appl. No.: 13/372,512

(22) Filed: Feb. 14, 2012

(51) Int. Cl. H04N 7/26

(52) U.S. Cl. 375/240.26; 375/E07.2

(57) ABSTRACT

Concepts and technologies are described herein for multi-layer rate control. In accordance with the concepts and technologies disclosed herein, a video server obtains video data and encodes the video data into a multi-layer video stream. Layers of the video stream cart be output buffers and the buffers can be monitored to determine bit usage. A rate controller can obtain bit usage feedback for each layer of the encoded video stream and determine, based upon the bit usage feedback, a quantization parameter associated with each layer of the encoded video stream. In determining the quantization parameters, the rate controller can consider not only bitrates of the entire encoded video stream, but also bitrates and bit usage feedback associated with each layer of the encoded video stream. Further encoding can be based upon the quantization parameters determined by the video server.

### BACKGROUND

Variations in bitrates of encoded video data can pose problems for various video delivery and storage mechanisms. For example, videos can be interrupted if bitrates exceed available bandwidth. Similarly, if bitrates are reduced during streaming or transmission of the video, sonic details of the video may be lost or removed from the video to accommodate the lower bitrates, which may be noticeable to viewers. To address some problems posed by these variations, some systems employ bitrate control mechanisms to regulate bitrates of the encoded video data and/or to manage the bitrates during transmission. One such approach includes analyzing the bitstream and determining a maintainable bitrate for the entire bitstream. This approach may be practical for some non-scalable bitstreams.

With scalable video bitstreams, however, this approach to controlling bitrate variations and/or bitrates can also impact performance and the user experience. For example, one approach to rate control for scalable video is to encode each layer of the video using the same approach used to encode an entire video stream as discussed above. This approach also may fail to provide an ideal user experience. In particular, because of the manner in which scalable video is sometimes transferred, some layers of the video data contain more or less data than other layers. As such, applying simple rate control mechanisms to the entire layered bitstreams, while reducing variations, may disproportionately affect some layers of the encoded video content. For example, if a base layer includes the bulk of information in the layered video data, the base layer of the video may be most significantly impacted by applying a bitrate control on the entire layered video stream. Furthermore, if each layer is simply encoded in accordance with a particular determined bandwidth requirement, this approach may fail to maximize quality of the various layers. Such a reduction may negatively impact the user experience more than the variations eliminated or reduced by applying the bitrate control mechanism,

Furthermore, scalable video is sometimes used during video conferencing and/or other applications for multiple classes of devices that have varied downlink and/or uplink bandwidth capabilities. Thus, using traditional rate control mechanisms may result in reduced quality of the various bitstreams to accommodate a receiver's bandwidth constraints, thus resulting in reduced quality for all of the users. For example, if a video server serves video to two receivers, one with 300 Kbps bandwidth and a second with 500 Kbps bandwidth, the video server may encode the video as a scalable video stream having a base layer encoded at 300 Kbps and an enhancement layer encoded at 200 Kbps. Because a rate controller associated with the video server often is imperfect, at times the base layer may be encoded at less than the targeted 300 kbps, resulting in a reduced quality of the overall stream that fails to maximize the bandwidth available to the second receiver. In this example, if the base layer falls to 280 Kbps, the maximum stream receivable by the second device may be 480 Kbps, which fails to utilize the available bandwidth and provides a less-than-ideal user experience. Thus, applying traditional rate control mechanisms to scalable video and/or independently applying rate control mechanisms to layers of multi-layer video stream can adversely affect the various bitstreams and reduce the quality of the video stream.

It is with respect to these and other considerations that the disclosure made herein is presented.

### SUMMARY

Concepts and technologies are described herein for multi-layer rate control. In accordance with the concepts and technologies disclosed herein, a video server applies rate control mechanisms to multiple layers of encoded video data while maintaining and taking into consideration dependencies of the multiple layers of video data. According to various embodiments, bit usage feedback information is obtained by a rate controller executing at the video server. The bit usage feedback information includes feedback indicators associated with each of multiple layers of encoded video content of an encoded video stream. According to some embodiments, the bit usage feedback information is obtained from an encoder encoding raw video data and outputting encoded video, from monitoring the encoded video stream, and/or from real or virtual buffers into which the multiple layers of encoded video content are output by the encoder prior to or during transmission or streaming of the encoded video. In some embodiments, the functionality of the buffers is provided by leaky bucket virtual buffers.

The rate controller obtains the feedback indicators and associates each of the feedback indicators with a respective layer of the video content. The rate controller also can consider feedback associated with a particular layer when considering any layer above that particular layer. For example, if the rate controller obtains bit usage feedback associated with a base layer, this bit usage feedback can be considered when considering bit usage of enhancement layers as well. As such, dependencies between the various layers of the encoded video can be considered during application of the multi-layer rate control mechanisms described herein.

According to some embodiments, the rate controller also can be configured to generate quantization parameters indicating how bitrates of the layers are to be controlled. In particular, the rate controller can determine multiple quantization parameters, each of the quantization parameters being generated for a respective layer of the video stream and taken into account when considering higher layers of the video stream. Thus, the quantization parameters can also be determined while considering and accounting for dependencies between the multiple layers of the video stream. The rate controller can be configured to output the quantization parameters to the encoder, and the encoder can adjust bitrates of the various layers based upon the quantization parameters. As such, the video server can provide multi-layer rate control by controlling bitrates of each layer of the video stream while taking into account dependencies of the layers of the video stream, instead of, or in addition to, controlling a bitrate associated with a layer independently or controlling a bitrate associated with the entire videos stream.

According to one aspect, a video server obtains video data from a local or remote data storage device. The video server executes an encoder configured to encode the video data into a multi-layer video stream. The encoder outputs the video stream to buffers, and the buffers track or output bit usage feedback corresponding to amounts or numbers of bits that are not transmitted to a client device receiving the encoded video stream. As such, the bit usage feedback can correspond to an amount or number of bits that exceeds available network resources. A rate controller executing at the video server can monitor the buffers and/or obtain the bit usage feedback for each layer of the encoded video stream.

According to another aspect, the rate controller can determine, based upon the bit usage feedback, a quantization parameter associated with each layer of the encoded video stream. In determining the quantization parameters, the rate controller can consider not only bitrates of the entire encoded video stream, but also bitrates and bit usage feedback associated with each layer of the encoded video stream. Furthermore, the rate controller can be configured to consider bit usage feedback associated with a particular layer of the encoded video stream when analyzing each layer above that layer, thereby taking into account dependencies of enhancement layers upon lower layers of the video. Thus, embodiments of the concepts and technologies disclosed herein can be used to maximize bitrates for the base layer and the lowest enhancement layers before bandwidth is used for higher enhancement layers. Additionally, some embodiments of the concepts and technologies disclosed herein cart be used to maximize bitrates of a particular layer by moving residual bit budget associated with the particular layer (due to imperfect rate control) to a next higher layer for each layer considered.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an illustrative operating environment for the various embodiments disclosed herein.

FIG. 2 is a flow diagram showing aspects of a method for providing multi-layer rate control, according to an illustrative embodiment.

FIG. 3 is a flow diagram showing aspects of a method for determining quantization parameters, according to an illustrative embodiment.

FIG. 4 is a computer architecture diagram illustrating an illustrative computer hardware and software architecture for a computing system capable of implementing aspects of the embodiments presented herein.

### DETAILED DESCRIPTION

The following detailed description is directed to concepts and technologies for multi-layer rate control. According to the concepts and technologies described herein, a video server obtains video data from a data storage device. The video server can host or execute an encoder. The encoder can be configured to encode the video data into a multi-layer video stream. The encoder can output the video stream to multiple buffers. In particular, each layer of the video stream can be passed into a buffer and monitored during streaming or transmission to determine bit usage. The buffers or other mechanisms can track or output bit usage feedback corresponding to amounts or numbers of bits that are not transmitted with the encoded video stream. In some embodiments, the bit usage feedback corresponds to a degree to which the encoded video stream transfer rates exceed available network resources.

A rate controller can monitor the buffers and/or obtain the bit usage feedback for each layer of the encoded video stream and determine, based upon the bit usage feedback, a quantization parameter associated with each layer of the encoded video stream. In determining the quantization parameters, the rate controller can consider not only bitrates of the entire encoded video stream, but also bitrates and bit usage feedback associated with each layer of the encoded video stream. Furthermore, the rate controller can be configured to consider bit usage feedback associated with a particular layer of the encoded video stream when analyzing each layer above that layer, thereby taking into account dependencies of enhancement layers upon lower layers of the video. Thus, embodiments of the concepts and technologies disclosed herein can be used to maximize bitrates for the base layer and the lowest enhancement layers before bandwidth is used for higher enhancement layers. Additionally, sonic embodiments of the concepts and technologies disclosed herein can be used to maximize bitrates of a particular layer by moving residual bit budget associated with a particular layer (due to imperfect rate control) to a next higher layer for each layer considered.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawings, in which like numerals represent like elements throughout the several figures, aspects of a computing system, computer-readable storage medium, and computer-implemented methodology for multi-layer rate control will be presented.

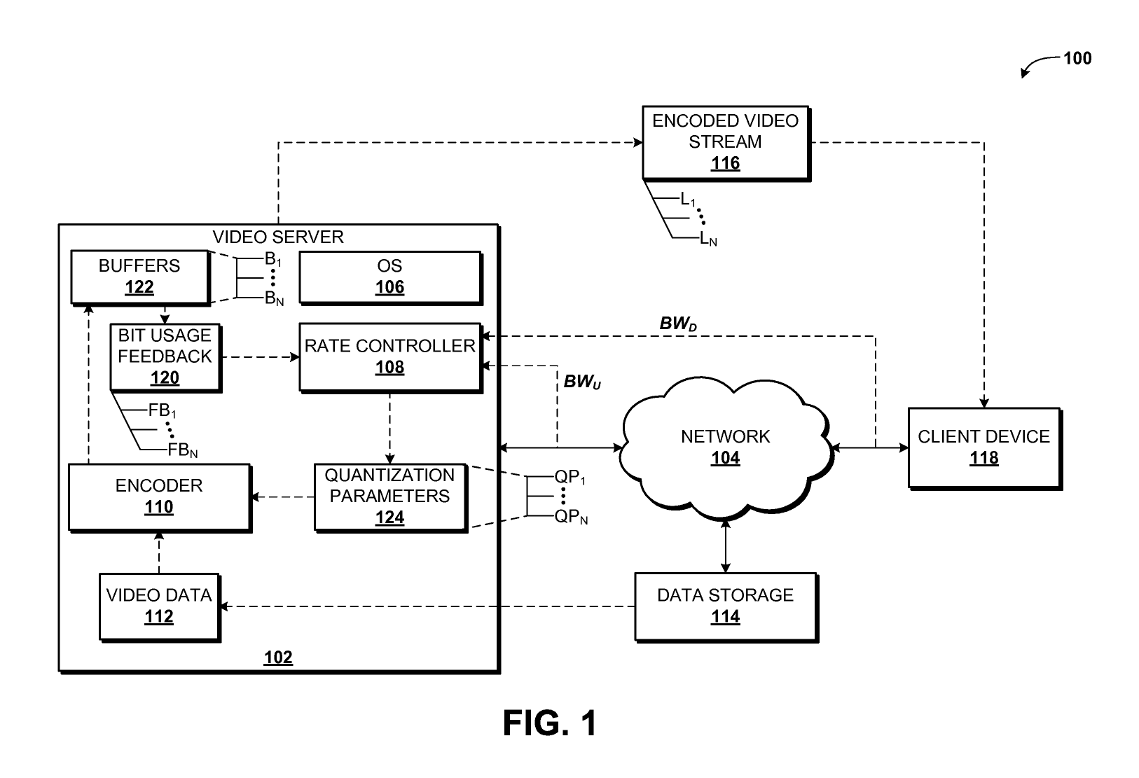

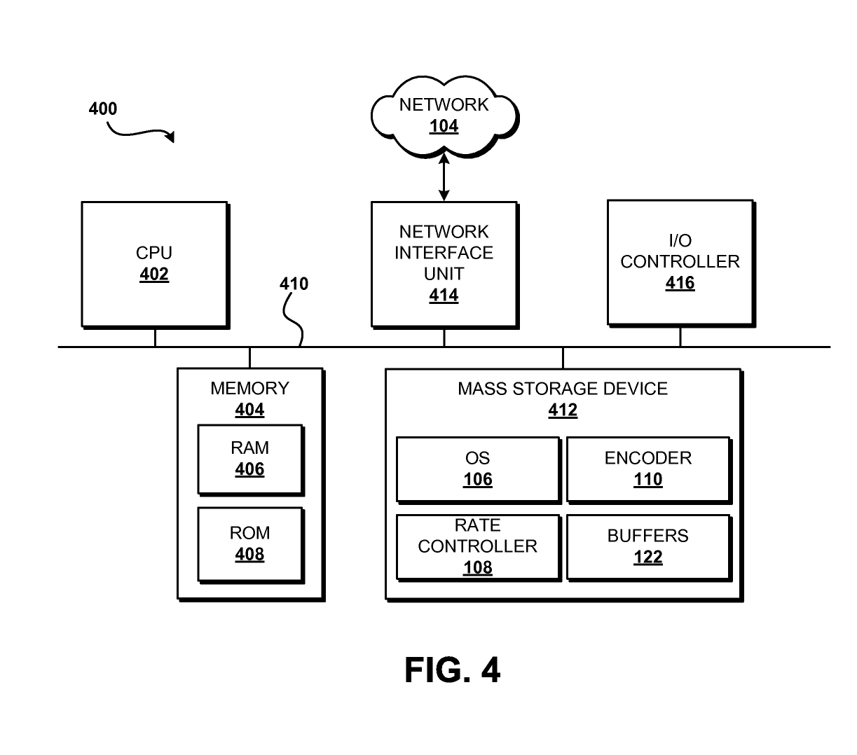

Referring now to FIG. 1, aspects of one operating environment 100 for the various embodiments presented herein will be described. The operating environment 100 shown in FIG. 1 includes a video server 102. In some embodiments, the video server 102 operates as part of or in communication with, a communications network (“network”) 104, though this is not necessarily the case. According to various embodiments, the functionality of the video server 102 is provided by a server computer; a personal computer (“PC”) such as a desktop, tablet, or laptop computer system; a handheld computer; an embedded computer system; or another computing device. Thus, while the functionality of the video server 102 is described herein as being provided by server computer, it should be understood that these embodiments are illustrative, and should not be construed as being limiting in any way. One illustrative computing architecture of the video server 102 is illustrated and described in additional detail below with reference to FIG. 4.

The video server 102 can be configured to execute an operating system 106 and one or more software modules such as, for example, a rate controller 108, an encoder 110, and/or other software modules. While the rate controller 108 and the encoder 110 are illustrated in FIG. 1 as residing at the video server 102, it should be understood that this is not necessarily the case. In particular, the rate controller 108 and/or the encoder 110 can be embodied as separate devices or modules in communication with the video server 102, if desired. As such, the illustrated embodiment should be understood as being illustrative and should not be construed as being limiting in any way.

The operating system 106 is a computer program for controlling the operation of the video server 102. The software modules are executable programs configured to execute on top of the operating system to provide various functions described herein for providing multi-layer rate control. Because additional and/or alternative software, application programs, modules, and/or other components can be executed by the video server 102, the illustrated embodiment should be understood as being illustrative and should not be construed as being limiting in any way.

The encoder 110 is configured to receive video data 112 such as video frames, raw video data, or other video information. In some embodiments, the video data 112 is received or retrieved from a data storage 114 operating in communication with the network 104 and/or the video server 102. Thus, the functionality of the data storage 114 can be provided by one or more data storage devices including, but not limited to, databases, network data storage devices, hard drives, memory devices, or other real or virtual data storage devices. In some other embodiments, the data storage 114 includes a memory device or other data storage associated with the video server 102. As such, while FIG. 1 illustrates the data storage 114 as residing remote from the video server 102, it should be understood that this embodiment is illustrative, and should not be construed as being limiting in any way.

According to various embodiments, the encoder 110 is configured to encode the video data 112 to obtain two or more layers of video information. The layers of video information can be output by the encoder 110 and transmitted or streamed by the video server 102 as an encoded video data stream (“encoded video stream”) 116. As shown, the encoded video stream 116 can include multiple video layers L₁ . . . , L_{N} (hereinafter collectively and/or generically referred to as “layers L”). As is generally understood, the first layer L₃ can correspond to a base layer of the encoded video stream 116 and each of the subsequent layers L can correspond to enhancement layers of the encoded video stream 116.

The encoded video stream 116 can be received or accessed by a client device 118 and at least the base layer L₁ of the encoded video stream 116 can be viewed. Depending upon the ability of the client device 118 to establish and/or sustain a network connection capable of receiving each of the multiple layers L of the encoded video stream 116, the base layer L₁ of the encoded video stream 116 can be viewed at the client device 118 with detail provided by the one or more enhancement layers L₂ (not shown in FIG. 1) through L_{N}). As such, the client device 118 can receive and view the encoded video stream 116 with various layers of detail, according to the ability of the client device 118 to establish and/or sustain network bandwidth for receiving the multiple layers L of the encoded video stream 116. It should be understood that this embodiment is illustrative, and should not be construed as being limiting in any way.

According to various embodiments of the concepts and technologies disclosed herein, the rate controller 108 is configured to obtain bit usage feedback data (“bit usage feedback”) 120 from the encoder 110 (as shown in FIG. 1), or by monitoring the encoded video stream 116 output by the encoder 110. In other embodiments, the rate controller 108 is configured to monitor, or receive data indicating the bit usage feedback 120 from, other reporting mechanisms associated with or incorporated into, the video server 102 such as the buffers 122 described below. The rate controller 108 also can be configured to access, receive, or determine a downlink bandwidth BW_{D} from each subscribed client such as the client device 118, as well as an uplink bandwidth BW_{U}, both of which can be inputs to the rate controller 108. The uplink bandwidth BW_{U} and the downlink bandwidth BW_{D} can be used to determine a target bitrate of each “sub-stream” of the encoded video stream 116 and therefore can be considered an input to the rate controller 108. As used herein, the term “sub-stream” can include and/or contain a base layer L₁ and several successive enhancement layers L of an encoded video stream 116. According to some embodiments, the video server 102 determines a target bitrate associated with the encoded video stream 116 based, at least partially, upon the downlink bandwidth BW_{D}. According to some embodiments, the video server 102 imposes a limitation that the maximum target bitrate of any sub-stream of the encoded video stream 116 cannot exceed the uplink bandwidth BW_{U} associated with the video server 102, and a limitation that the target bitrate of any sub-stream of the encoded video stream 116 cannot exceed the downlink bandwidth BW_{D} associated with the client that consumes the sub-stream, for example, the client device 118. It should be understood that these embodiments are illustrative and should not be construed as being limiting in any way.

The bit usage feedback 120 can indicate an amount or number of bits that are not transmitted to a recipient of the encoded video stream 116. Thus, the bit usage feedback 120 can be analyzed to ascertain how much of the video data 112 encoded as the encoded video stream 116 is prevented, dropped, or lost during transmission or streaming at any particular time. Thus, the bit usage feedback 120 can be understood by the video server 102 to be an indicator of bandwidth or other aspects of the transmission medium used to stream the encoded video stream 116.

As shown in FIG. 1, the bit usage feedback 120 can include data indicating a number of feedback indicators FB₁ . . . FB_{N} (hereinafter generically referred to as the “feedback indicators FB” and/or collectively referred to as the “bit usage feedback 120”). The multiple feedback indicators FB can correspond, respectively, to the multiple layers L discussed above. As such, for example, the feedback parameter FB₁ can correspond to a bit usage feedback indicator associated with the base layer L₁ of the encoded video stream 116. It should be understood that this embodiment is illustrative, and should not be construed as being limiting in any way.

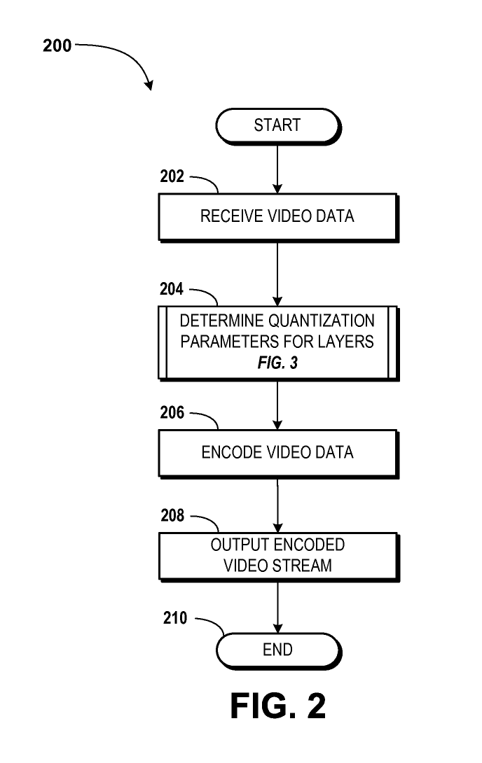

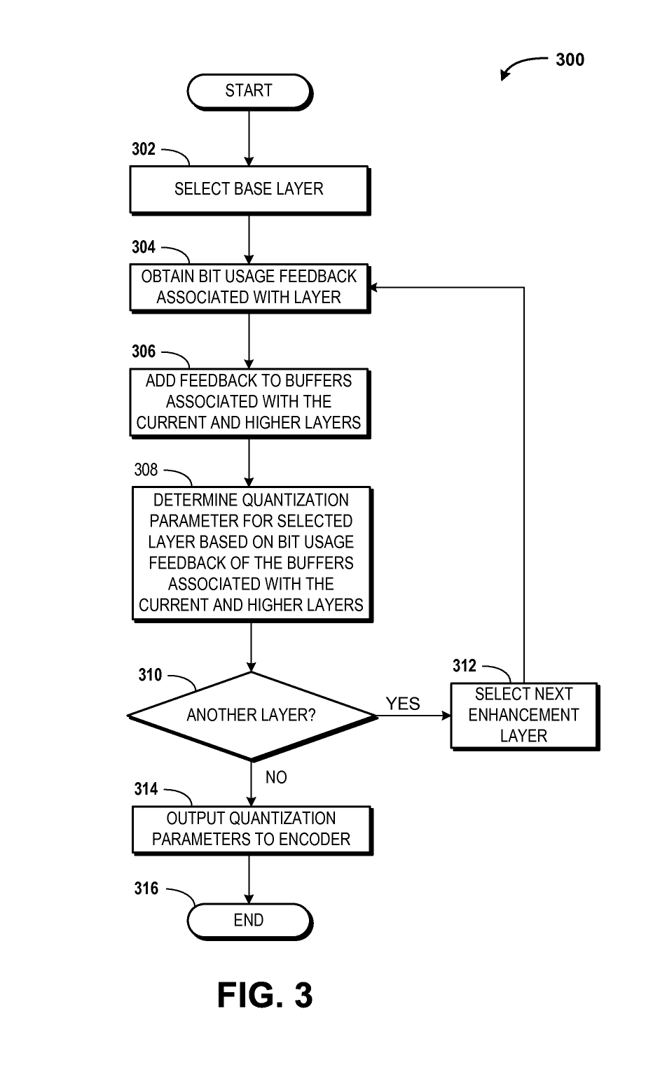

The rate controller 108 can be configured to load the bit usage feedback (“bit usage feedback”) 120 into multiple leaky bucket buffers B₁ . . . B_{N} (hereinafter generically referred to as a “buffer B” and/or collectively referred to as the “buffers 122”). In the illustrated embodiment, the rate controller 108 loads the bit usage feedback 120 into buffers B₁ . . . B_{N}, which can correspond, respectively, to the multiple layers L and/or the multiple feedback parameters FB. As will be explained in more detail below, particularly with reference to FIGS. 2-3, the rate controller 108 can be configured to obtain the bit usage feedback 120, load feedback parameters FB associated with the multiple layers L into the buffers 122, and determine, for each of the layers L, corresponding quantization parameters (hereinafter collectively referred to as the “quantization parameters 124”). The rate controller 108 can be configured to output the quantization parameters 124 to the encoder 110, and the encoder 110 can use the quantization parameters 124 during encoding of the video data 112.

According to various embodiments of the concepts and technologies disclosed herein, the video server 102 can execute the rate controller 108 and the encoder 110 to control bitrates of each layer L of the encoded video stream 116, while taking dependencies between the layers L into account. Thus, for example, bit usage rate information associated with a base layer L₁ of the encoded video stream 116 can be identified in the bit usage feedback 120, and added to a corresponding buffer B₁. This bit usage rate information also can be added to any buffers B associated with any other layers L of the encoded video stream 116, thereby ensuring that any bitrate control mechanisms applied to the encoded video stream 116 take into account at least the bit usage rate information associated with the base layer L₁ before considering individual bit usage rates of the enhancement layers L₂ . . . L_{N}.

In one contemplated example, a video includes three layers L. Thus, the bit usage rate information such as the feedback indicator FB₁ associated with the base layer L₁ can be added to the buffers B₁, B₂, and B₃. As such, during consideration of a feedback indicator FB₂ associated with the first enhancement layer L₂, the video server 102 can consider the bitrate feedback indicator FB₁ associated with the base layer L₁ and the first enhancement layer L₂. Thus, as layers L of a video are considered, bitrates for enhancement layers L can be dependent upon bitrates of the base layer L₁ and lower enhancement layers L. It should be understood that this embodiment is illustrative, and should not be construed as being limiting in any way.

According to embodiments, the video server 102 receives the video data 112 and the encoder 110 encodes the video data 112. The encoded video data 112 can be output by the encoder 110 as the encoded video stream 116. According to some embodiments, the encoded video stream 116 passes through or into the buffers 122. According to various embodiments, each layer L of the encoded video stream 116 can pass into a respective buffer B included as part of the buffers 122.

In some embodiments, the buffers 122 self-report or are monitored by the rate controller 108 or other modules, devices, or software to determine or obtain the bit usage feedback 120, as explained above. As noted above, the bit usage feedback 120 can include multiple feedback indicators FB, which can correspond to the multiple buffers B included within the buffers 122. The rate controller 108 can be configured to analyze the bit usage feedback 120 and to generate quantization parameters 124 based upon the bit usage feedback 120. According to various embodiments, the quantization parameters 124 include respective quantization parameters QP₁ . . . QP_{N}, which can be determined for each of the multiple layers L of the encoded video stream 116, and can take into account dependencies between the layers L as explained above with regard to the buffers B.

The rate controller 108 can output the quantization parameters 124 to the encoder 110, and the encoder 110 can encode the video data 112 in accordance with the quantization parameters 124. As such, it can be appreciated that the video server 102 can monitor multiple buffers B associated with the multiple layers L of the encoded video stream 116, determine quantization parameters 124 for each of the layers L, and control encoding of the video data 112 based upon the determined quantization parameters 124. Thus, embodiments of the concepts and technologies disclosed herein can take bitrate usage information for each layer L of an encoded video stream 116 while taking into account dependencies between the layers L the encoded video stream 116 when applying rate control mechanisms, instead of, or in addition to, controlling a bitrate associated with a layer independently or controlling a bitrate associated with the entire output encoded video stream 116.

Thus, embodiments of the concepts and technologies disclosed herein can include controlling bitrates of each layer L of the encoded video stream 116. In some embodiments, this can improve performance of the video server 102 and/or improve the user experience by ensuring that low levels L of the encoded video stream 116 are encoded at the maximum rate prior to encoding enhancement layers L. In some embodiments, the video server 102 is configured to determine the maximum bitrates based upon the uplink bandwidth BW_{U} and/or the downlink bandwidth BW_{D}. Furthermore, when considering the multiple layers L and the dependencies between the multiple layers L, the video server 102 can be configured to maximize bitrates of a particular layer L_{N+1} by moving a residual bit budget associated with the particular layer L_{N}, for example a residual bit budget that results from imperfect rate control, to a next higher layer L_{N+1} for each layer L considered. These and other aspects of the concepts and technologies disclosed herein for multi-layer rate control are described in more detail below with reference to FIGS. 2-4.

FIG. 1 illustrates one video server 102, one network 104, and one client device 118. It should be understood, however, that some implementations of the operating environment 100 include multiple video servers 102, multiple networks 104, and no or multiple client devices 118. Thus, the illustrated embodiments should be understood as being illustrative, and should not be construed as being limiting in any way.

Turning now to FIG. 2, aspects of a method 200 for providing multi-layer rate control will be described in detail, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in its entirety. Some or all operations of the methods disclosed herein, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For purposes of illustrating and describing the concepts of the present disclosure, the methods disclosed herein are described as being performed by the video server 102 via execution of the rate controller 108 and/or the encoder 110. It should be understood that these embodiments are illustrative, and should not be viewed as being limiting in any way. In particular, additional or alternative devices can provide the functionality described herein with respect to the methods disclosed herein via execution of various software modules in addition to, or instead of, the rate controller 108 and/or the encoder 110.

The method 200 begins at operation 202, wherein the video server 102 receives video data such as the video data 112 described above with reference to FIG. 1. As explained above, the video data 112 can be stored at the video server 102 or can be stored at a remote data storage device such as the data storage 114. Thus, operation 202 can include retrieving the video data 112 from a local or remote data storage device.

From operation 202, the method 200 proceeds to operation 204, wherein the video server 102 determines quantization parameters 124 for layers of video output to be generated by the video server 102. As shown in FIG. 1, the video output can correspond, in various embodiments, to the encoded video stream 116 and the multiple layers L of the encoded video stream 116. As such, operation 204 can include determining a respective quantization parameter QP for each layer L of the encoded video stream 116. Additional details of determining the quantization parameters 124 are set forth below with reference to FIG. 3.

It should be understood that the method 200 can be repeated a number of times by the video server 102 during streaming of the encoded video stream 116. As such, a first iteration of the method 200 may use default quantization parameters 124 to encode the video data 112, as the operations described herein with respect to FIG. 3 may not yet have been performed by the video server 102. Subsequent iterations of the method 200 can rely upon the quantization parameters 124 determined in operation 204 and illustrated in more detail below with reference to FIG. 3. As such, the embodiment of the method 200 illustrated in FIG. 2 may or may not correspond to a particular iteration of the method 200 during streaming of video content from the video server 102. As such, the illustrated embodiment should not be construed as being limiting in any way.

From operation 204, the method 200 proceeds to operation 206, wherein the video server 102 encodes the video data 112. According to various embodiments, the video server 102 encodes the video data 112 in accordance with the quantization parameters 124 determined in operation 204. As explained in detail with reference to FIG. 1, the video server 102 can encode the video data 112 using the quantization parameters 124 to provide multi-layer rate control. More particularly, bit usage feedback information associated with each layer L of the encoded video stream 116 can be used to fill leaky bucket buffers such as the buffers 122 associated with the layer L and any higher layers L. For example, bits associated with the first enhancement layer L₂ can contribute to fullness of an associated buffer B₂ and all buffers B₃ . . . B_{N} associated with any other enhancement layers L₃ . . . L_{N}. It should be understood that this embodiment is illustrative, and should not be construed as being limiting in any way.

Thus, embodiments of the concepts and technologies disclosed herein can control a bitrate associated with each layer L of an encoded video stream 116. While providing the multi-layer rate control described herein, embodiments of the video server 102 can consider not only overall bitrates, but also bitrates of layers L, dependencies between the layers L. Thus, an enhancement layer L of an encoded video stream 116 may not be analyzed until a base layer L of the encoded video stream 116 is considered, thus enforcing dependencies between the enhancement layer L and the base layer L. It should be understood that this embodiment is illustrative, and should not be construed as being limiting in any way.

From operation 206, the method 200 proceeds to operation 208, wherein the video server 102 outputs the encoded video stream 116. The encoded video stream 116 can correspond to the video data 112 received in operation 202 and encoded in operation 206 in accordance with the quantization parameters 124 determined in operation 204. The video server 102 can be configured to stream the encoded video stream 116 to the client device 118, to other video servers, and/or to broadcast the encoded video stream 116. As such, operation 208 can include outputting the encoded video stream 116 to various devices or network connections including, but not limited to, those shown in FIGS. 1 and 4. From operation 208, the method 200 proceeds to operation 210. The method 200 ends at operation 210.

Referring now to FIG. 3, aspects of a method 300 for determining quantization parameters 124 are described in detail, according to an illustrative embodiment. In particular, as explained above with reference to FIG. 2, FIG. 3 illustrates additional details of the method 200 that can be provided during execution of operation 204 described above. Because the functionality described herein with reference to FIG. 3 can be provided at other times, it should be understood that this embodiment is illustrative, and should not be construed as being limiting in any way.

The method begins at operation 302, wherein the video server 102 selects a base layer L₁ of the encoded video stream 116. As is generally understood, the encoded video stream 116 can include multiple layers L, and the base layer L₁ can correspond to a first layer of the encoded video stream 116. According to various embodiments, the base layer L₁ can, but does not necessarily, include a majority of the video data 112 associated with the encoded video stream 116 and/or a disproportionate amount of the video data 112 that is greater than portions of the video data 112 included in other layers L of the encoded video stream 116. According to some embodiments, the video server 102 selects the base layer L₁ as a starting point to determine the quantization parameters 124, though this is not necessarily the case. As such, the illustrated embodiment should be understood as being illustrative of one contemplated embodiment and should not be construed as being limiting in any way.

From operation 302, the method 300 proceeds to operation 304, wherein the video server 102 obtains the bit usage feedback data 120 or other data indicating bit usage information associated with the selected layer L. In a first iteration of operation 304, the bit usage information can include a feedback parameter FB₁ associated with the base layer L₁. In subsequent iterations of operation 304, as will be described below, the bit usage information can include a feedback parameter FB_{N} associated with a selected layer L_{N}. It should be understood that these embodiments are illustrative, and should not be construed as being limiting in any way.

As explained above with reference to FIG. 1, the bit usage information can be included in the bit usage feedback 120. As explained above, in some embodiments the bit usage feedback 120 is received by the rate controller 108 from the encoder 110. In other embodiments, the rate controller 108 monitors the encoded video stream 116 or the buffers 122 to determine the bit usage feedback 120. In still other embodiments, the rate controller 108 receives the bit usage feedback 120 or other data for indicating hit usage from other devices or modules that are configured to monitor the encoded video stream 116 or the buffers 122. Thus, operation 304 can include obtaining the bit usage feedback 120, receiving the bit usage feedback 120, and/or receiving other information, as well as identifying bit usage information in the bit usage feedback 120 associated with a particular level L being analyzed by the video server 102.

From operation 304, the method 300 proceeds to operation 306, wherein the video server 102 adds the bit usage feedback associated with a particular level L_{N} being analyzed to any buffers 122 associated with the particular level L_{N} and all higher levels L. During a first iteration of the method 300, for example, wherein the base layer L₁ is being analyzed, the feedback parameter FB₁ associated with the base layer L₁ can be added to all of the buffers 122, corresponding to a buffer B₁ for the base layer L₁ and buffers B₂ . . . B_{N} for the enhancement layers L₂ . . . L_{N}. As such, it can be appreciated that bit usage information associated with the base layer L₁ can be considered and added to buffers B associated with each layer L of the encoded video stream 116.

In subsequent iterations of the method 300, the video server 102 can add bit usage information from the layer L being analyzed to an associated buffer B and any higher buffers 122. As such, for a first enhancement layer L₂, the feedback information associated with the layer L₂ can be added to a buffer B₂ associated with the layer L₂ and buffers B₃ . . . B_{N} associated with any higher enhancement layers L₃ . . . L_{N}. In some embodiments, however, the video server 102 can omit the feedback information associated with the layer L₂ from the buffer B₁ associated with the base layer L₁. Thus, some embodiments of the video server 102 consider the dependency of layers upon lower layers and not upon higher layers. It should be understood that this embodiment is illustrative, and should not be construed as being limiting in any way.

From operation 306, the method 300 proceeds to operation 308, wherein the video server 102 determines a quantization parameter 124 associated with the selected layer L. Thus, for example, in a first iteration of the method 300, the video server 102 can determine the quantization parameter QP₁ for the base layer L₁ in operation 308. In subsequent iterations of the method 300, the video server 102 can determine quantization parameters 124 for each analyzed layer L of the encoded video stream 116. It should be understood that the quantization parameters 124 can indicate how the encoder 110 is to encode each layer L of the encoded video stream 116 and can be based upon the various buffers B filled in operation 306 and bitrate usage feedback of the buffers B filled in operation 306. Thus, for example, operation 308 can include examining the bit usage feedback of the buffers B associated with the analyzed layer L as well as any higher layers L. Thus, the quantization parameters 124 determined by the video server 102 can be based upon the dependencies discussed above with regard to the layers L.

From operation 308, the method 300 proceeds to operation 310, wherein the video server 102 determines if the encoded video stream 116 includes additional layers L to be analyzed. If the video server 102 determines, in operation 310, that the encoded video stream 116 includes additional layers L to be analyzed, the method 300 proceeds to operation 312, wherein the video server 102 selects a next enhancement layer L of the encoded video stream 116. According to various embodiments, the video server 102 selects the enhancement layers L in order, beginning with a first enhancement layer L₂ and continuing until a last enhancement layer L_{N} is considered. Because the layers L can be considered in other orders, it should be understood that this embodiment is illustrative, and should not be construed as being limiting in any way.

From operation 312, the method 300 returns to operation 304. Operations 304-310 can be repeated by the video server 102 until the video server 102 determines, in any iteration of operation 310, that another layer L of the encoded video stream 116 does not remain for analysis. In another embodiment, the video server 102 can stop repeating the method 300 if available bandwidth is exhausted at any time. If the video server 102 determines, in any iteration of operation 310, that another layer L is not included in the encoded video stream 116, the method 300 proceeds to operation 314.

At operation 314, the video server 102 outputs the quantization parameters 124 determined in operation 308 to the encoder 110. As explained above, with reference to FIG. 2, the encoder 110 can modify encoding of the video data 112 according to the quantization parameters 124. Thus, the methods 200 and 300 can be executed by the video server 102 to provide multi-layer rate control. From operation 314, the method 300 proceeds to operation 316. The method 300 ends at operation 316.

FIG. 4 illustrates an illustrative computer architecture 400 for a device capable of executing the software components described herein for providing multi-layer rate control. Thus, the computer architecture 400 illustrated in FIG. 4 illustrates an architecture for a server computer, a mobile phone, a PDA, a smart phone, a desktop computer, a netbook computer, a tablet computer, a laptop computer, or another computing device. The computer architecture 400 may be utilized to execute any aspects of the software components presented herein.

The computer architecture 400 illustrated in FIG. 4 includes a central processing unit 402 (“CPU”), a system memory 404, including a random access memory 406 (“RAM”) and a read-only memory (“ROM”) 408, and a system bus 410 that couples the memory 404 to the CPU 402. A basic input/output system containing the basic routines that help to transfer information between elements within the computer architecture 400, such as during startup, is stored in the ROM 408. The computer architecture 400 further includes a mass storage device 412 for storing the operating system 106, the rate controller 108, the encoder 110, and the buffers 122. Although not shown in FIG. 4, the mass storage device 412 also can be configured to store the video data 112, data corresponding to the encoded video stream 116, the optimization parameters 124, and/or other data, if desired.

The mass storage device 412 is connected to the CPU 402 through a mass storage controller (not shown) connected to the bus 410. The mass storage device 412 and its associated computer-readable media provide non-volatile storage for the computer architecture 400. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 400.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 400. For purposes the claims, the phrase “computer storage medium” and variations thereof, does not include waves, signals, and/or other transitory and/or intangible communication media, per se.

According to various embodiments, the computer architecture 400 may operate in a networked environment using logical connections to remote computers through a network such as the network 104. The computer architecture 400 may connect to the network 104 through a network interface unit 414 connected to the bus 410. It should be appreciated that the network interface unit 414 also may be utilized to connect to other types of networks and remote computer systems, for example, the client device 118. The computer architecture 400 also may include an input/output controller 416 for receiving and processing input from a number of other devices, including a keyboard, mouse, or electronic stylus (not shown in FIG. 4). Similarly, the input/output controller 416 may provide output to a display screen, a printer, or other type of output device (also not shown in FIG. 4).

It should be appreciated that the software components described herein may, when loaded into the CPU 402 and executed, transform the CPU 402 and the overall computer architecture 400 from a general-purpose computing system into a special-purpose computing system customized to facilitate the functionality presented herein. The CPU 402 may be constructed from any number of transistors or other discrete circuit elements, which may individually or collectively assume any number of states. More specifically, the CPU 402 may operate as a finite-state machine, in response to executable instructions contained within the software modules disclosed herein. These computer-executable instructions may transform the CPU 402 by specifying how the CPU 402 transitions between states, thereby transforming the transistors or other discrete hardware elements constituting the CPU 402.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 400 in order to store and execute the software components presented herein. It also should be appreciated that the computer architecture 400 may include other types of computing devices, including hand-held computers, embedded computer systems, personal digital assistants, and other types of computing devices known to those skilled in the art. It is also contemplated that the computer architecture 400 may not include all of the components shown in FIG. 4, may include other components that are not explicitly shown in FIG. 4, or may utilize an architecture completely different than that shown in FIG. 4.

Based on the foregoing, it should be appreciated that technologies for multi-layer rate control have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

We claim:

1. A computer-implemented method for providing multi-layer rate control for video transmission, the computer-implemented method comprising performing computer-implemented operations for:
obtaining video data from a data storage device;
determining a plurality of quantization parameters associated with a plurality of layers to be included in an encoded video stream;
encoding, at the video server, the video data in accordance with the quantization parameters to obtain the encoded video stream; and
outputting the encoded video stream.

2. The method of claim 1, wherein determining the plurality of quantization parameters further comprises:
selecting a base layer of the encoded video stream;
obtaining bit usage information comprising bit usage feedback associated with the base layer and further bit usage feedback associated with an enhancement layer;
adding the bit usage feedback to a first buffer associated with the base layer and a second buffer associated with the enhancement layer;
adding the further bit usage feedback to the second buffer;
determining a first of the plurality of quantization parameters for the base layer and second of the plurality of quantization parameters for the enhancement layer.

3. The method of claim 2, further comprising:
determining if the encoded video stream includes another layer to be analyzed;
outputting the plurality of quantization parameters, in response to determining that the encoded video stream does not include the other layer to be analyzed; and
selecting a next enhancement layer of the encoded video stream, in response to determining that the encoded video stream includes the other layer to be analyzed.

4. The method of claim 1, wherein outputting the encoded video stream comprises streaming the encoded video stream to a client device in communication with the video server.

5. The method of claim 1, wherein outputting the encoded video stream comprises outputting the encoded video stream to a plurality of buffers.

6. The method of claim 5, wherein the plurality of buffers comprises a first buffer associated with a base layer of the encoded video stream, a second buffer associated with a first enhancement layer of the encoded video stream, and a third butter associated with a second enhancement layer of the encoded video stream.

7. The method of claim 6, further comprising obtaining bit usage information comprising a first bit usage feedback parameters associated with the base layer, a second bit usage feedback associated with the first enhancement layer, and a third bit usage feedback associated with the second enhancement layer.

8. The method of claim 7, further comprising:
adding the first bit usage feedback to the first buffer, the second buffer, and the third buffer;
adding the second bit usage feedback to the second buffer and the third buffer;
adding the third bit usage feedback to the third buffer; and
determining
a first of the plurality of quantization parameters based upon the first buffer, the second buffer, and the third buffer,
a second of the plurality of quantization parameters based upon the second buffer and the third buffer, and
a third of the plurality of quantization parameters based upon the third buffer.

9. The method of claim 1, wherein outputting the encoded video stream comprises broadcasting the encoded video stream.

10. A computer storage medium having computer readable instructions stored thereupon that, when executed by a computer, cause the computer to:
obtain video data from a data storage device;
determine a plurality of quantization parameters associated with a plurality of video layers to be included in an encoded video stream;
encode, at the computer, the video data in accordance with the quantization parameters to obtain the encoded video stream; and
output the encoded video stream.

11. The computer storage medium of claim 10, wherein the instructions for determining the plurality of quantization parameters further comprise instructions that, when executed by the computer, cause the computer to:
select a base layer of the encoded video stream;
obtain first hit usage feedback associated with the base layer and second hit usage feedback associated with an enhancement layer of the encoded video stream;
add the first bit usage feedback to a first buffer associated with the base layer and a second buffer associated with the enhancement layer;
add the second bit usage feedback to the second buffer;
determine,
a first quantization parameter for the base layer based upon an amount of data in the first buffer and the second buffer, and
a second quantization parameter for the enhancement layer based upon an amount of data in the second buffer.

12. The computer storage medium of claim 11, further comprising computer readable instructions that, when executed by the computer, cause the computer to:
output the first quantization parameter and the second quantization parameter, in response to determining that the encoded video stream does not include another layer to be analyzed; and
select a next enhancement layer of the encoded video stream, in response to determining that the encoded video stream includes the other layer to be analyzed.

13. The computer storage medium of claim 10, wherein outputting the encoded video stream comprises outputting the encoded video stream to a plurality of buffers.

14. The computer storage medium of claim 13, wherein the plurality of buffers comprises a first buffer associated with a base layer of the encoded video stream, a second buffer associated with a first enhancement layer of the encoded video stream, and a third buffer associated with a second enhancement layer of the encoded video stream.

15. The computer storage medium of claim 14, further comprising computer readable instructions that, when executed by the computer, cause the computer to obtain bit usage information comprising a
first bit usage feedback parameters associated with the base layer,
a second bit usage feedback associated with the first enhancement layer, and
a third bit usage feedback associated with the second enhancement layer.

16. The computer storage medium of claim 15, further comprising computer readable instructions that, when executed by the computer, cause the computer to:
add the first bit usage feedback to the first buffer, the second buffer, and the third buffer;
add the second bit usage feedback to the second buffer and the third buffer;
add the third bit usage feedback to the third buffer; and
determine
a first of the plurality of quantization parameters based upon the first buffer, the second buffer, and the third buffer,
a second of the plurality of quantization parameters based upon the second buffer and the third buffer, and
a third of the plurality of quantization parameters based upon the third buffer.

17. A computer storage medium having computer readable instructions stored thereupon that, when executed by a computer, cause the computer to:
obtain video data from a data storage device;
encode, at the computer, the video data to obtain the encoded video stream;
output the encoded video stream to buffers;
select a base layer of the encoded video stream;
obtain bit usage feedback having first bit usage information associated with the base layer and second bit usage information associated with an enhancement layer of the encoded video stream;
add the first bit usage information to a first of the buffers associated with the base layer and a second of the buffers associated with the enhancement layer;
add the second bit usage feedback to the second of the buffers;
determine, based upon the first buffer and the second buffer, a first quantization parameter of the base layer, and based upon the second buffer, a second quantization parameter of the first enhancement layer; and
encode, at the computer, the video data in accordance with the quantization parameters.

18. The computer storage medium of claim 17, further comprising computer readable instructions that, when executed by the computer, cause the computer to:
output the first quantization parameter and the second quantization parameter, in response to determining that the encoded video stream does not include another layer to be analyzed; and
select a next enhancement layer of the encoded video stream, in response to determining that the encoded video stream includes the other layer to be analyzed.

19. The computer storage medium of claim 17, further comprising computer readable instructions that, when executed by the computer, cause the computer to broadcast the encoded video stream to a plurality of devices in communication with the computer.

20. The computer storage medium of claim 17, wherein determining at least one of the first quantization parameter or the second quantization parameter further comprises determining a target bitrate associated with at least one layer of the encoded video stream, the target bitrate being based, at least partially, upon a downlink bandwidth of a subscribed client, wherein the downlink bandwidth does not exceed an uplink bandwidth associated with the computer.
